(19) United States
(12) Patent Application Publication
(10) Pub. No.: US 2009/0228314 A1
(43) Pub. Date: Sep. 10, 2009

(54) Accelerated Service Delivery Service

(75) Inventors: William Joseph Athey, North Potomac, MD (US); Praduemn K. Goyal, Holmdel, NJ (US); Shallin Joshi, Brookfield, CT (US); Kevin J. McCarthy, Freehold, NJ (US)

Correspondence Address: DUKE W. YEE, YEE AND ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/043,745

(22) Filed: Mar. 6, 2008

(51) Int. Cl. G06Q 10/00; G06F 17/30

(52) U.S. Cl. 705/7

(57) ABSTRACT

In one illustrative embodiment, a computer implemented method for an accelerated service delivery service is provided. The computer implemented method comprises receiving input data describing a source service model and a target service model, comparing the source service model and the target service model and, identifying differences between the source service model and the target service model to form a first set of identified differences, and responsive to an identification of differences, creating a set of transforms for the first set of identified differences. The computer implemented method further identifying differences between the set of transforms and the described target service model, to form a second set of identified differences. The computer implemented method evaluating the second set of identified differences to determine whether results are acceptable and responsive to a determination that results are acceptable, accepting the target service model.

### BACKGROUND OF THE INVENTION

1. Field of the Invention

The present invention relates generally to an improved data processing system and more specifically to a computer implemented method, an apparatus and a computer program product for accelerated service delivery service.

2. Description of the Related Art

Businesses are operating in a highly competitive environment today. Time-to-market is a typical key to success in retaining and gaining market share in the highly competitive business environment. Service provider enterprises often face elongated service delivery intervals and have to go through several iterations of incremental changes before a planned service is ready for market. Gaps between user expectation and system solution are often not discovered until late in the user acceptance testing and operation readiness testing phases. A large number of change requests are then initiated by the users within the late test phases. Handling the requests cause delays to market and typically lead to cost overruns.

There are several factors in the current service development process employed by service providers that may contribute to the delays and cost overruns. Services may not have been fully defined in the early stages of the project and the service operations process may have not been fully understood or documented. New business processes may not be intuitive and are not easily bridged from the existing, more familiar business process. The “as is” business model, representing the current environment, and the “to-be” business model, representing the target environment, may not have been completely developed when defining business requirements.

### BRIEF SUMMARY OF THE INVENTION

According to one embodiment of the present invention, a computer implemented method for an accelerated service delivery service is provided. The computer implemented method comprises receiving input data describing a source service model and a target service model, comparing the source service model and the target service model, and determine whether there are differences between the source service model and the target service model. The computer implemented method responsive to a determination that there are differences, identifies differences between the source service model and the target service model to form a first set of identified differences, and responsive to an identification of differences, creates a set of transforms for the first set of identified differences. The computer implemented method further determines whether there are differences between the set of transforms and the target service model, and responsive to a determination that there are differences, identifies differences between the set of transforms and the described target service model, to form a second set of identified differences. The computer implemented method evaluates the second set of identified differences to determine whether results are acceptable, and responsive to a determination that results are acceptable, accepts the target service model.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system is shown in which illustrative embodiments may be implemented;

FIG. 3 is a block diagram of high level components for an accelerated service delivery service in accordance with illustrative embodiments;

FIG. 4 is a flowchart of a service description process for an accelerated service delivery service of FIG. 3 in accordance with illustrative embodiments; and

FIG. 5 is a flowchart of a process of the accelerated service delivery service of FIG. 3 in accordance with illustrative embodiments.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

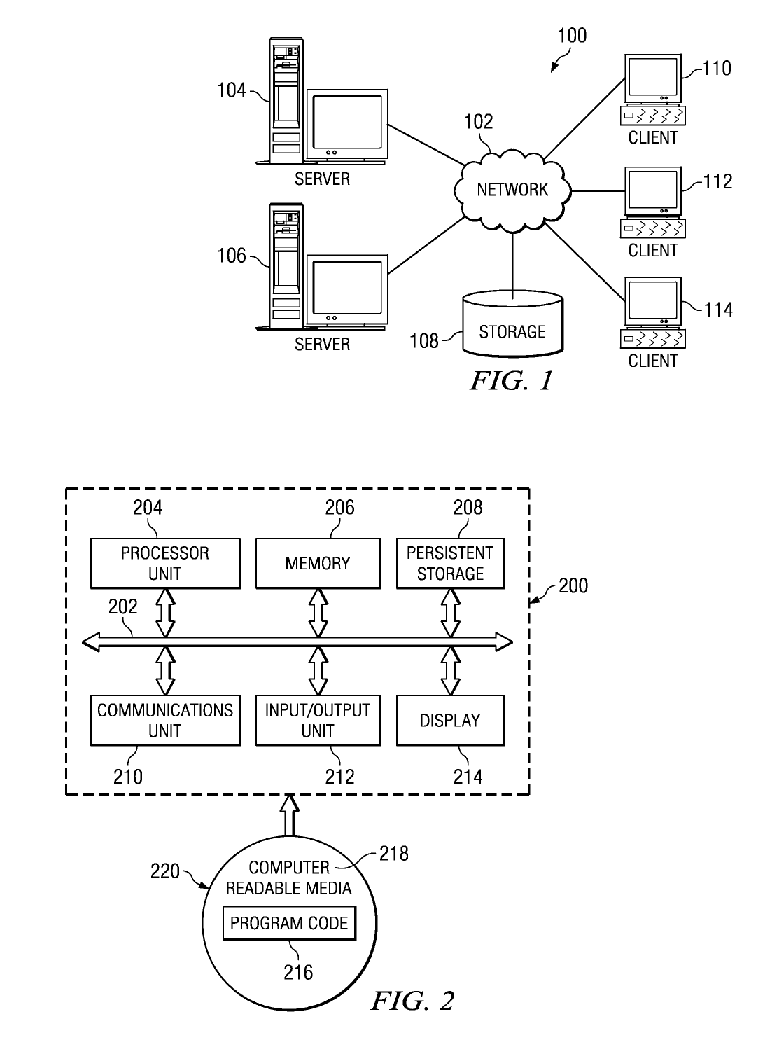

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

In one example, a number of users, on client 110 and client 112 may provide business and operational information regarding a current service or product and a proposed upgrade of the current service as a target service or product. The information may be gathered by graphical user interface input, sent through network 102 and collected on server 104. Server 104 contains an implementation of an accelerated service delivery service that processes the collected information. The accelerated service delivery service on server 104 interacts with the client 110 and client 112 in an iterative manner to analyze the input data, compare the source and target service models to produce differences. The differences require transform definitions to be generated to traverse the current service model to the target service model. The transforms are modeled and compared with the target service model. The results are again analyzed, with some elements being optimized to meet expectation of the users. The users are able to collaborate throughout the process via network 102 using the common accelerated service delivery service provided.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric, multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Business requirements are typically expressed in terms of system solutions that describe how something will work rather than in terms of the business needs describing what is needed. The waterfall style development process in use today may further exacerbate the situation with gaps in the interpretation and translation as requirements are elaborated on and translated into a product design and an implementation of that design. While iterative development processes and agile processes have been proposed, these processes typically focus on being flexible in incorporating change and progressively refining the implementation based on iterative user feedback These processes require much time and effort to refine proposed systems to meet requirements.

Illustrative embodiments receive input based on business and operational information regarding a current service or product and a proposed upgrade of the current service as a target service or product. The information may be gathered by graphical user interface input, or programmatic means, enabling those providing the requirements and input data to interact in an iterative manner to analyze the input data, compare the source and target service models to produce differences. Transform definitions are generated to resolve differences identified between the current service model and the target service model. The transforms are modeled and compared with the target service model. The results are again analyzed, with some elements being optimized to meet the expectation expressed by the users. The users are therefore able to collaborate throughout the process via a network of connected devices using the common accelerated service delivery service provided. Emphasis is placed on the design phase to reduce the rework typically required in other development processes. Optimization is an incremental modification of a component to improve the component and thereby reduce or minimize the identified difference between the current service model and the target service model, for a particular aspect of the service models. A goal of optimization is to provide a result closer to what was expected or requested of that component. Optimization may be realized through different techniques comprising, adjustment of a function, including code change, a different choice of solution as in device support or sizing of a device, and resetting of a requirement.

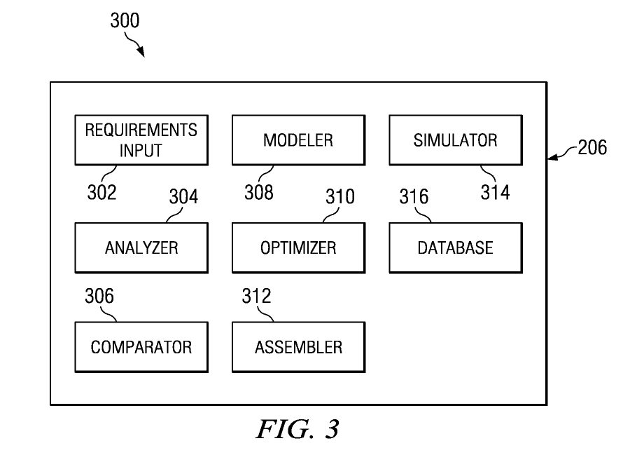

With reference to FIG. 3, a block diagram of high level components for an accelerated service delivery service in accordance with illustrative embodiments is shown. The high level components are shown within memory 206 of system 200 of FIG. 2. Although shown within the memory the components may also reside in other memory locations. The components may be loaded into memory 206 when needed for processing.

Accelerated service delivery service 300 contains a number of components comprising a requirements input 302, an analyzer 304, a comparator 306, a modeler 308, an optimizer 310, an assembler 312, a simulator 314 and a database 316. Accelerated service delivery service 300 provides a coordinating function for the components contained within the service, such as, but not limited to, shared utilities and a graphical user interface.

Requirements input 302 provides a capability to capture data associated with a project. The input may use the graphical user interface to allow users to input data describing the application or business entity of interest as well as data describing upgrade or replacement elements. The application is defined as the current service model, while the upgrade or replacement elements define the target service model. In an alternative the input may also support programmatic extraction of data from sources such as source code or documentation in machine readable format. The term source service model and “as is” business model may be used interchangeably. In a similar manner, target service model and “to be” business model may also be used interchangeably.

Analyzer 304 provides a capability to analyze the data input. Analysis may be performed from business perspective to include business goals, strategies, objectives, use cases, priorities and requirements obtained in the data. The analyzer supports the cycle of definition, build, review and analyzes to refine descriptions of both the source service model and the target service model.

Comparator 306 provides a capability to examine source service model and target service model elements and determine differences when differences exist. The comparator is used within the modeling process to refine the outcome to achieve the target service model. When differences are identified, transforms are required to be defined. The transforms specify how to traverse from the source service model to the target service model for a respective element.

Modeler 308 provides a capability to receive input definitions of the transforms and model the transforms to provide proposed results. The transforms were determined through use of the analysis and comparator components that identified differences between the source service model and target service model. The modeler is used to model the transforms to resolve the identified differences.

Optimizer 310 provides a capability to further refine an identified transform. During the modeling when a difference cannot be resolved, an associated transform may be identified as a candidate for optimization. The goal of the optimization is to selective alter the results to meet the expectations. The optimizer provides services ranging from code rework to re-specification of the transform.

Assembler 312 gathers the elements of a model together to form unit for testing and analysis. Assembler 312 packages the various pieces that form a model in preparation for the modeling or simulation activity. For example, assembler 312 gathers functional service descriptor information into a unit for creating the service component model.

Simulator 314 provides a capability to exercise proposed changes to the “as-is” model to aid in the analysis of requirements for the target “to be” service model. The simulator provides a mechanism to define how the current system delivers results associated with the “as-is” system.

Database 316 provides a capability to contain and manage the various collections of resources comprising the “as-is” and “to be” business models, service component model, operational service models, business use cases, and functional and operational service descriptors. Operational service descriptors describe operational attributes of a respective system. Operational service descriptors typically provide information comprising configuration, performance, capacity and tuning attributes as well as information on operational skills. The resources are used throughout the data collection, modeling and verification processes. Business related resources are collected and stored within the database along with operational resources and model data. For example, business goals and objectives as well as business use case information is collected through receiving input from users or programmatically acquired sources.

Functional services descriptors as well as operational service descriptors combine to form model input for service component and “as is” business models. The “as is” and “to be” business models are maintained within the data base as are the operational service model and financial reports and return on investment estimates. The operational service model may be viewed as a performance monitoring tool used in conjunction with the “as is” and “to be” business models. Transformation requirements identified as a result of comparing and analyzing differences between models and between requirements and their related models may be stored in the database for use and modification. The transforms may also be used to provide data flows and overall system model information.

Using the components of the accelerated service delivery service provides a capability for a new requirement development process. The new process defines the business process transformation in terms of an “as is” or current service model and a “to-be” or target service model business process models. The requirements are then defined in terms of a transformation between the source service model and the target service model. Requirement development in this new process is organized in three phases of business analysis, business modeling and solution composition.

In the business analysis phase, business goals, objectives and priorities are established and business use cases for the new service of the target service model are outlined. This drives the business modeling, and simulation phase wherein the source service model and target service model process models are developed, simulated and refined. The process models and business requirements from the analysis phase then guide the solution composition.

To eliminate and avoid gaps in understanding and interpretation, collaboration techniques such as joint application requirements and joint application design are used during the three phases of requirement development. The emphasis is on the front end of the project to avoid the more costly and time consuming changes made in the latter stage of application development.

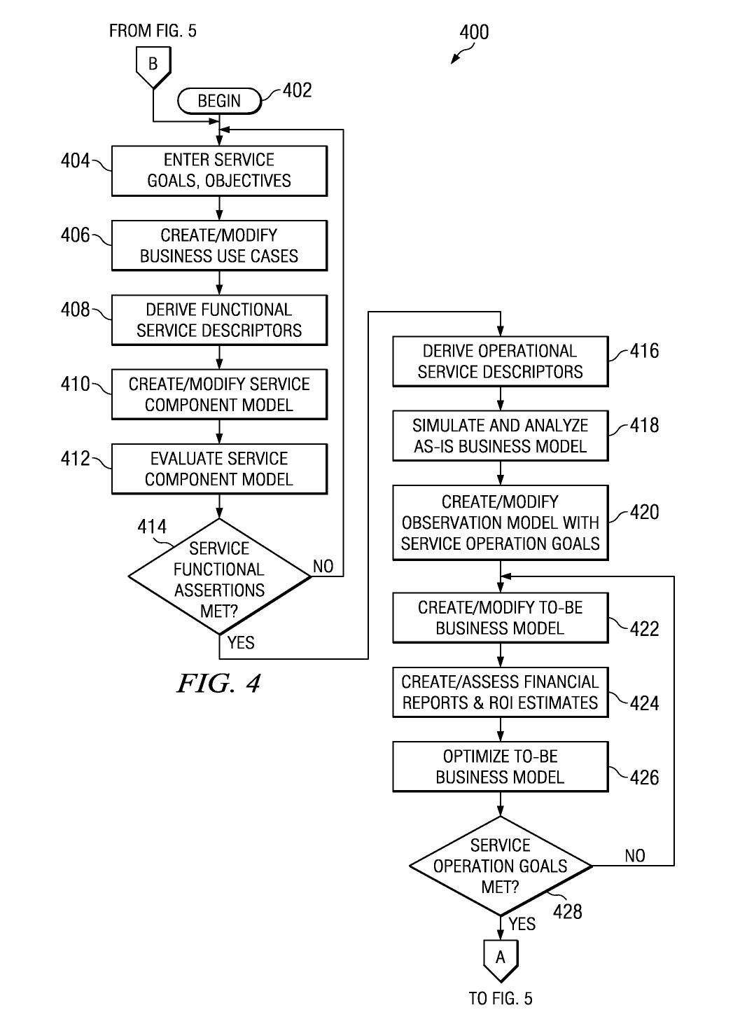

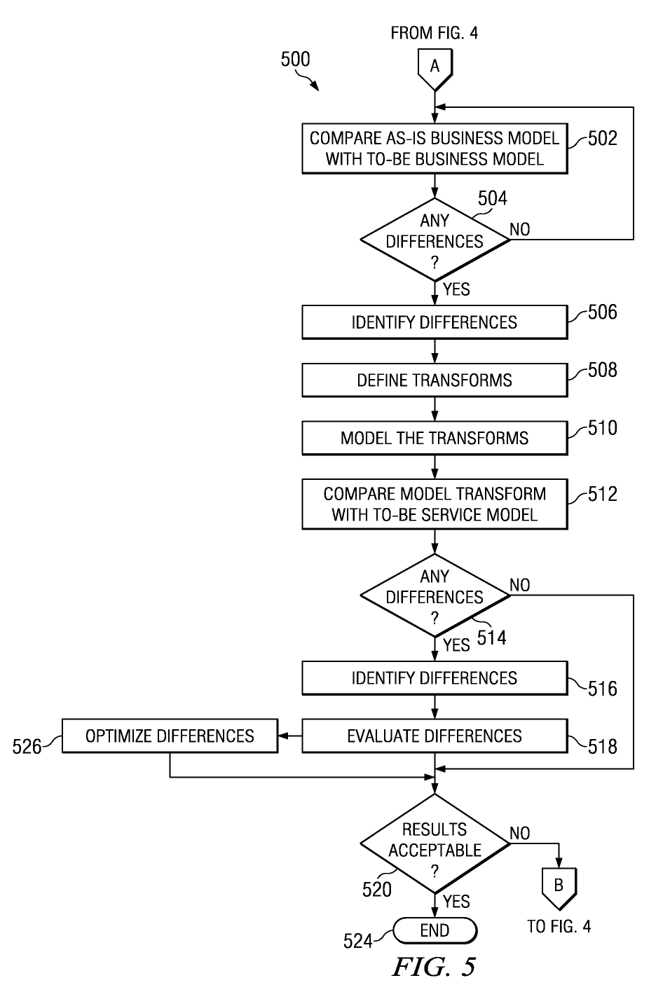

With reference to FIG. 4, a flowchart of a service description process for an accelerated service delivery service of FIG. 3, in accordance with illustrative embodiments is shown. Service description process 400 is an example of a process used to provide the necessary definition of the services of the target service model. The service descriptions are used as input into the process of the accelerated service delivery service 300 of FIG. 3.

Process 400 starts (step 402) and receives input entry of service goals and objectives (step 404). Input may be provided via users through a graphic user interface or programmatically using computer-usable documentation and code in source or non-source forms. For example, the input may provide a print interface dialog description using existing or proposed code and documentation. Other sources may also provide business input in the form of strategies and needs.

The input is further gathered and used to create or modify business use cases (step 406). The business use cases define what and how function is used from a business perspective. The input is analyzed to derive functional service descriptors (step 408). The functional service descriptors describe what function is required in the form of services. For example, a forms application may require a special print service using prepared form paper. The functional service descriptors maybe in the form of high level requirements or objectives. Functional service descriptors describe the various functions comprising a system from an information technology perspective. Using the derived functional service descriptors, service components are identified to form a service component model (step 410). The service components are typically the materialization of the service descriptors in the form of implementation elements. Identification provides the implementation elements needed to create the service component model of step 410. Models include the creation of test scripts or scenarios used to affirm the degree to which the model relates to the real systems on which the model is based. In step 410, the various components are collected to form a set of service components comprising the source or “as is” service model. A set refers to one or more items. In this example, a set of service components is one or more service components. For example, a derived functional service descriptor may relate to an improved response time for a web service. The associated functional service component may be identified as a larger server. The larger server is then added to the source service model.

The service component model is then evaluated against the underlying requirements to be met by the service component model (step 412). A determination is made whether the service component model meets the expectations in the form of the previously derived functional service assertions (step 414). Functional service assertions are quantified metrics forming a target or objective that a component is to meet. A collection or set of functional service assertions may then represent the service objective of a model. If the service component model meets the service functional assertions a “yes” results. If the service component model fails to meet the service assertions a “no” results.

When a “no” is received in step 414, there is a need to identify and re-define service goals and objects by returning to step 404. When a “yes” is obtained in step 414, process 400 derives operational service descriptors (step 416). Operational service descriptors are derived in a manner similar to those of functional service descriptors, however these descriptors relate to operational aspects of the service

Simulate and analyze “as is” business model is performed using the previously obtained behavioral specifications and requirements (step 418). Simulating the “as is” business model in step 418 provides a base for further development or creation or modification of an observation model with the service operation goals (step 420). The observation model provides a capability to specifically initialize, test and evaluate features of a model. For example, if a new print service was added to an application, test scripts or scenarios could be invoked during the modeling. The exercise of the new print service could then be monitored as it performed using the script with results captured and evaluated as part of the observation model. The observation model need not be a separate model but rather a tool for examining the working of other models. The operation goals may include key performance indicators for both business and operational perspectives, including response time for functions, and return on investment.

Create or modify the “to be” business model provides the target service model (step 422). The target service model is based on the “as is” service model plus added or changed requirements determined in the prior steps. The target service model comprises the business goals and objectives articulated in the functional service descriptors and the operational service descriptors. The target service model is modeled to create and assess financial reports and return on investment estimates (step 424).

Observation and examination of the target service model operation aids in modification or optimization of the “to be” business model (step 426). Optimization was previously described as incremental modification to improve a respective component to reduce or minimize the difference between the current and target values. A determination is then made whether the service operation goals have been met (step 428). If the goals have been met, a “yes” results. If the goals have not been met then a “no” results. When a “yes” is obtained in step 428, the “to be,” target service model is ready for comparison with the “as is,” source service model and process 400 moves to point A of FIG. 5 to begin process 500. When a “no” result is obtained in step 428, opportunities for refinement exist with respect to the “to be” service model. For example, if a goal not met was identified as a response time target not met, a service component related to the attainment of the goal may be a hardware element such as a telecommunication link having insufficient capacity or an under performing device. A modification of an existing component may be required or a new component may need to be added.

With reference to FIG. 5, a flowchart of a process of the accelerated service delivery service of FIG. 3 in accordance with illustrative embodiments is shown. Process 500 is an example of the accelerated service delivery service 300 of FIG. 3.

Process 500 starts and compares the source service model and target service model produced by process 400 of FIG. 4 (step 502). The data typically includes descriptions of current and proposed function as well as other factors of the application of interest. Business information is also provided in the form of goals and objectives, such as service levels or performance related metrics. The input process produces a described source service model and described target service model.

A comparison of the information in the described source service model with that of the described target service model is performed to determine if there are any differences (step 504). The determination is made on a functional basis as well as other defined metrics used to described the service models. Factors include various elements such as key performance indicators, representing technology issues to return on investment indicators, representing business perspectives. When there are differences, a “yes” results in step 504. When no differences are found there is a “no” result in step 504.

When a “no” is obtained in step 504, process 500 skips back to step 502 to perform another comparison at a later date. When a “yes” is obtained in step 504, a first set of differences is identified (step 506). The identification may be a simple listing or temporary storing of the differences to enable subsequent processing. Each identified difference in the first set of differences represents a potential to miss a needed requirement or failure to meet a target service model expectation. For each identified difference in the first set of differences, a transform is defined to form a first set of transforms (step 508). Each transform is defined to resolve a specific difference and allow the current service model to move toward the target service model. Transforms may be simple or complex and will cover both business and technology categories as needed. For example, a simple command line interface may be found in the source service model whereas the target service model requires a graphical user interface. The transform may define a simple input panel to replace the command line format. In another example, a business goal may be expressed as a service level improvement. The related transform may involve a set of operations to meet the revised expectation.

Having defined the first set of transforms, the transforms are then modeled using modeling tools suited for the task of business or technology based transforms (step 510). The model behavior of the transform is compared to the stated needs of the target service model (step 512). A determination is made whether there are differences between the modeled behavior of the transform and the expected behavior of the target service model (514). When there are no differences, a “no” results. When there are differences a “yes” is obtained. When a “no” is obtained in step 514, process 500 skips to step 520.

When a “yes” is obtained in step 514, the differences are identified to form a second set of differences (step 516). Having identified the second set of differences, each difference is evaluated for subsequent processing (step 518). The differences are then optimized (step 526). Optimization reduces or minimizes the difference between the source and target values. Optimization may include change in either source or target values or modification of the means used to meet the values. The means may include rework of assumptions, requirements or functional elements. Optimization may then require resources in the form of business or technology factors to improve the result of the identified difference. For example, optimizing the target service model to create an optimized target service model, may include modifications comprising re-defining a service objective to an achievable value or adjusting a specification to allow more choices to meet a target, or tuning a code segment for performance.

A determination is then made whether the results are acceptable (step 520). Acceptance is the form of determining whether the modeled and simulated result meets the target service model requirements. When results are not acceptable a “no” result is obtained and the differences are re-evaluated. Re-evaluation provides an opportunity to review the inputs and results of the previous phases related to the elements or components involved in the identified differences and associated transforms and return to step 402 of process 400 of FIG. 4. The business analysis, modeling and simulation as well as the solution composition are reviewed to determine what adjustments if any can be made to better align the transform to produce a desired result. Target service model requirements may also form part of the review to determine if the expectations for the portion of the solution affected by the identified transform are appropriate. When the results of the transforms are within an acceptable range of the target service model expectations, a “yes” results and process 500 terminates thereafter (step 524).

Illustrative embodiments provide a capability to obtain and process business information regarding a current application service model and proposed upgrade or target service model. The information is gathered into accelerated service delivery service that processes the collected information. The accelerated service delivery service allows various users to interact with each in an iterative manner to analyze the input data, compare the source and target service models to identify differences. The identified differences cause the transform definitions to be generated to traverse from the current service model to the target service model. The transforms are modeled, simulated, and compared with the target service model expectations. The results are again analyzed, with some elements being optimized to meet expectations of the users. The users are able to collaborate throughout the process using the common accelerated service delivery service provided. Emphasis is therefore placed on collaboration throughout the design process rather than later stages of project development when using the accelerated service delivery service as described in the examples shown.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for an accelerated service delivery service, the computer implemented method comprising:
receiving a set of inputs describing a set of business services to form a received input;
creating a component service model from the received input;
determining whether service functional assertions of the service component model are met;
responsive to a determination that the service functional assertions are met, creating a set of operational service descriptors;
creating a source service model using the set of operational service descriptors, and an observation model;
creating a target service model from the received input and optimizing the target service model to create an optimized target service model;
determining whether service operation goals are met;
responsive to a determination that the service operation goals are met comparing the source service model and the target service model;
determining whether there are differences between the source service model and the target service model;
responsive to a determination that there are differences, identifying differences between the source service model and the target service model to form a first set of identified differences;
responsive to an identification of differences, creating a set of transforms for the first set of identified differences;
determining whether there are differences between the set of transforms and the target service model;
responsive to a determination that there are differences, identifying differences between the set of transforms and the target service model, to form a second set of identified differences;
evaluating the second set of identified differences to determine whether results are acceptable; and
responsive to a determination that results are acceptable, accepting the target service model.

2. The computer implemented method for an accelerated service delivery service of claim 1, wherein the step of responsive to identifying differences, creating a set of transforms for the first set of identified differences, further comprises:
modeling the set of transforms; and
comparing the set of transforms to the target service model.

3. The computer implemented method for an accelerated service delivery service of claim 1, wherein each transform is defined to resolve a respective identified difference in the first set of identified differences.

4. The computer implemented method for an accelerated service delivery service of claim 1, wherein evaluating the second set of identified differences to determine whether results are acceptable further comprises:
determining whether the results are acceptable; and
responsive to a determination that the results are not acceptable, optimizing differences in the set of differences.

5. A data processing system for an accelerated service delivery service, the data processing system comprising:
a bus;
a memory connected to the bus, wherein the memory comprising computer executable instructions;
a communications unit connected to the bus;
a display connected to the bus;
a processor unit connected to the bus wherein the processor unit executes the computer executable instructions to direct the data processing system to:
receive a set of inputs describing a set of business services to form a received input;
create a component service model from the received input;
determine whether service functional assertions of the service component model are met;
responsive to a determination that the service functional assertions are met, create a set of operational service descriptors;
create a source service model using the set of operational service descriptors;
create a target service model from the received input and optimize the target service model to create an optimized target service model;
determine whether service operation goals are met;
responsive to a determination that the service operation goals are met, compare the source service model and the target service model;
determine whether there are differences between the source service model and the target service model;
responsive to a determination that there are differences, identify differences between the source service model and the target service model to form a first set of identified differences;
responsive to an identification of differences, create a set of transforms for the first set of identified differences;
determine whether there are differences between the set of transforms and the target service model
responsive to a determination that there are differences, identify differences between the set of transforms and the target service model, to form a second set of identified differences;
evaluate the second set of identified differences to determine whether results are acceptable; and
responsive to a determination that results are acceptable, accept the target service model.

6. The data processing system for an accelerated service delivery service of claim 5, wherein responsive to an identification of differences, create a set of transforms for the first set of identified differences, further comprises;
model the set of transforms; and
compare the set of transforms to the target service model.

7. The data processing system for an accelerated service delivery service of claim 5, wherein each transform is defined to resolve a respective identified difference in the first set of identified differences.

8. The data processing system for an accelerated service delivery service of claim 5, wherein evaluate the second set of identified differences to determine whether results are acceptable further comprises:
determine whether the results are acceptable; and
responsive to a determination that the results are not acceptable, optimize differences in the set of differences.

9. A computer program product for an accelerated service delivery service, the computer program product comprising:
a computer-usable recordable medium embodying computer executable instructions thereon, the computer executable instructions comprising:
computer executable instructions for receiving a set of inputs describing a set of business services to form a received input;
computer executable instructions for creating a component service model from the received input;
computer executable instructions for determining whether service functional assertions of the service component model are met;
computer executable instructions responsive to a determination that the service functional assertions are met, for creating a set of operational service descriptors;
computer executable instructions for creating a source service model using the set of operational service descriptors;
computer executable instructions for creating a target service model from the received input and optimizing the target service model to create an optimized target service model;
computer executable instructions for determining whether service operation goals are met;
computer executable instructions responsive to a determination that the service operation goals are met for comparing the source service model and the target service model;
computer executable instructions for determining whether there are differences between the described source service model and a described target service model;
computer executable instructions responsive to a determination that there are differences, for identifying differences between the described source service model and a described target service model to form a first set of identified differences;
computer executable instructions responsive to an identification of differences, for creating a set of transforms for the first set of identified differences;
computer executable instructions for determining whether there are differences between the set of transforms and the described target service model
computer executable instructions responsive to a determination that there are differences, for identifying differences between the set of transforms and the described target service model, to form a second set of identified differences;
computer executable instructions for evaluating the second set of identified differences to determine whether results are acceptable; and
computer executable instructions responsive to a determination that results are acceptable, for accepting the target service model.

10. The computer program product for an accelerated service delivery service of claim 9, wherein the computer executable instructions responsive to identifying differences, for creating a set of transforms for the first set of identified differences, further comprises:
computer executable instructions for modeling the set of transforms; and
computer executable instructions for comparing the set of transforms to the described target service model.

11. The computer program product for an accelerated service delivery service of claim 9, wherein each transform is defined to resolve a respective identified difference in the first set of identified differences.

12. The computer program product for an accelerated service delivery service of claim 9, wherein the computer executable instructions for evaluating the second set of identified differences to determine whether results are acceptable further comprises:
computer executable instructions for determining whether the results are acceptable; and
computer executable instructions responsive to a determination that the results are not acceptable, for optimizing differences in the set of differences.
